(19) United States
(12) Patent Application Publication
(10) Pub. No.: US 2024/0328612 A1
(43) Pub. Date: Oct. 3, 2024

(54) LIGHT CONTROL PAN-TILT

(71) Applicant: TILTA INC., Burbank, CA (US)

(72) Inventors: Wenping Zeng, Shenzhen (CN); Kefeng Zhou, Shenzhen (CN)

(21) Appl. No.: 18/129,062

(22) Filed: Mar. 30, 2023

(51) Int. Cl. F21V 21/15; F16M 11/12; F21V 21/28

(52) U.S. Cl. CPC F21V 21/15; F16M 11/126; F21V 21/28

(57) ABSTRACT

The present disclosure provides a pan-tilt device for a light source. The pan-tilt device can support a light source and provide pan-tilt control of the light source using one or more motors. The pan-tilt device can be implemented as a bracket for mounting the light source on a support member (e.g., a tripod). The pan-tile device includes a longitudinal arm and an angled arm. The longitudinal arm couples the light source to the angled arm. The longitudinal arm has a first motor to tilt the light source relative to the angled arm. The angled arm has a second motor to pan the light source.

### TECHNICAL FIELD

The present disclosure relates to the technical field of controlling a light source, in particular, to a pan-tilt device for a light source.

### BACKGROUND

At present, in the field of photography, a light source is mainly fixed through a bracket, and the illumination path of the light source is manually controlled.

### SUMMARY

Aspects of the present disclosure provide a light control pan-tilt apparatus, which can overcome the limitation of light control in the prior art. In order to achieve the above object, the present disclosure provides the following schemes:

A light control pan-tilt apparatus comprises a center of gravity leveling mechanism, one or more rotating shaft mechanisms, and a control mechanism. The center of gravity leveling mechanism comprises a lateral adjusting mechanism and a longitudinal adjusting mechanism which can be used for adjusting the center of gravity of a device to be positioned at a center of the rotating shaft mechanism. The lateral adjusting mechanism comprises a chute area of a rotating shaft and a slide strip area of an arm, and the rotating shaft can slide relative to the arm; and the longitudinal adjusting mechanism comprises a chute area of a rotating shaft and a slide strip area of an arm, and the rotating shaft can slide relative to the arm.

The rotating shaft mechanism comprises a turntable and a main body. The turntable is provided with a rotor part of a motor, and the main body is provided with a stator part which rotates relative to the motor rotor; and the turntable can rotate relative to the main body.

The control mechanism comprises a rocker control terminal for controlling the direction of the light control pan-tilt apparatus, one or more buttons for controlling the operation mode of the light control pan-tilt apparatus, and an internal circuit motherboard coupled to the rocker control terminal and the one or more buttons. A bottom end of the control mechanism is provided with an interface area for connecting a light tripod, such that the control mechanism can be mounted on the light tripod.

The control mechanism of a light control pan-tilt includes software algorithm integration, intelligent path scanning, object tracking, etc.

Multiple light control pan-tilt apparatuses can be jointly controlled through software algorithm, so as to achieve multi-effect processing of light.

In some aspects, the disclosure provides a pan-tilt device for a light source. The pan-tilt device can support the light source and provide pan-tilt control of the light source using one or more motors. The pan-tilt device can be implemented as a bracket for mounting the light source on a support member (e.g., a tripod). The pan-tile device includes a longitudinal arm and an angled arm. The longitudinal arm couples the light source to the angled arm. The longitudinal arm has a first motor to tilt the light source relative to the angled arm. The angled arm has a second motor to pan the light source.

### BRIEF DESCRIPTION OF THE DRAWINGS

FIG. 1 is a schematic diagram illustrating a light pan-tilt apparatus according to the present disclosure.

FIG. 2 is a first exploded schematic diagram of the pan-tilt apparatus of FIG. 1 according to the present disclosure.

FIG. 3 is an exploded schematic diagram of a control terminal of the pan-tile apparatus of FIG. 1 according to the present disclosure.

FIG. 4 is schematic diagram of the control terminal according to the present disclosure.

FIG. 5 is a schematic diagram of an assembly of the present disclosure.

### DETAILED DESCRIPTION

The present disclosure will be described in conjunction with the accompanying drawings.

Aspects of the present disclosure provide apparatuses and methods for controlling the illumination path of a light source through remote wireless electronic control.

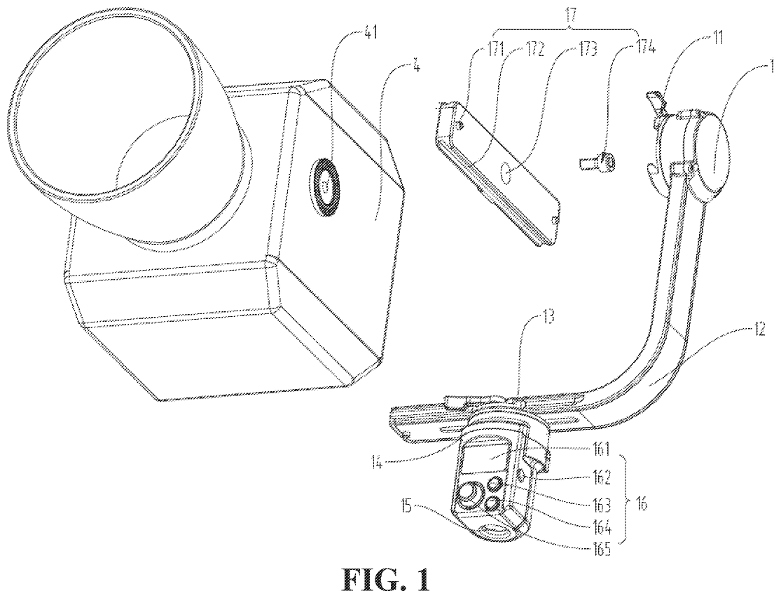

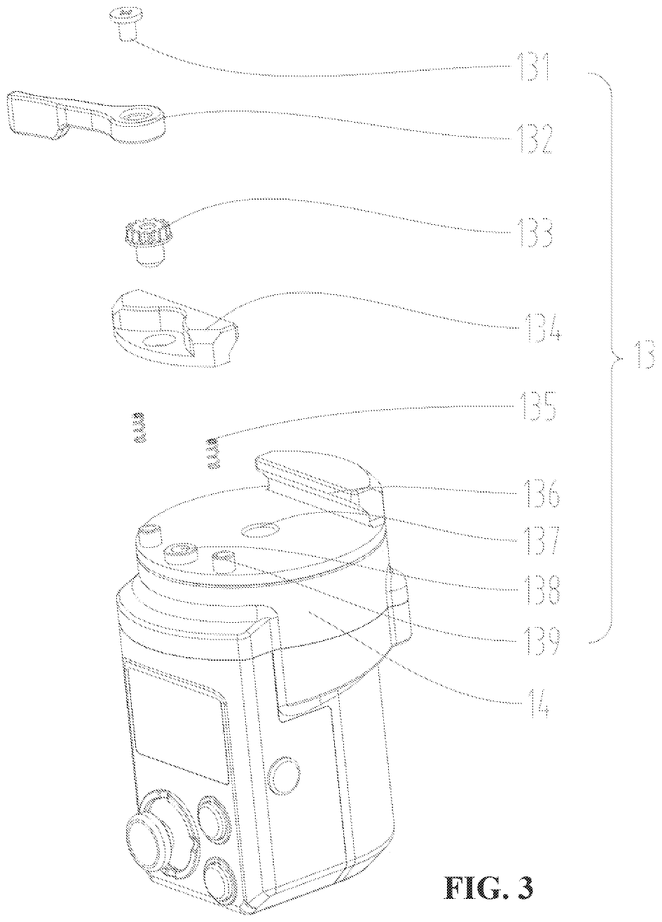

As shown in FIGS. 1-5, the present disclosure provides a light control pan-tilt apparatus 1, which comprises a first turntable 11, an arm 12 (e.g., a vertical arm), a second turntable 13, a main body 14, an interface 15, a control terminal 16, and a longitudinal arm 17.

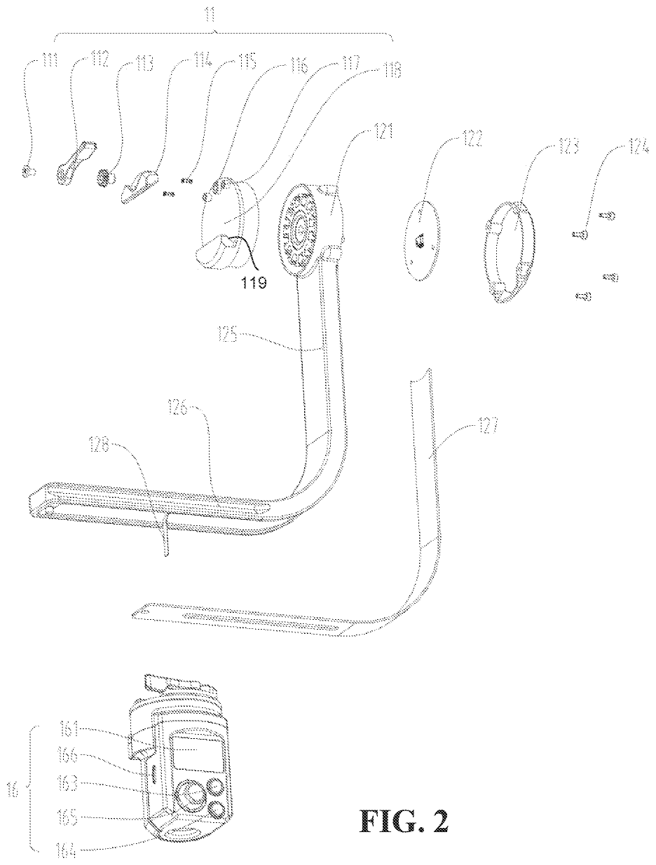

In the first turntable 11, a pressing block 114 (see FIG. 2) is arranged on a turntable main body 118. A spring 115 is arranged in a cylindrical hole 117 on the turntable main body 118, and between the pressing block 114 and the turntable main body 118, so as to provide the function of restoring and rebounding the pressing block 114. A wrench 112 is connected to a toothed screw 113 and connected to the threaded hole 117 against the pressing block 114. The wrench 112 can be used (or operated) to lock against the pressing piece 114, so as to lock a slide strip area 172 (e.g., see FIG. 1) of the longitudinal arm 17. The longitudinal arm 17 can slide in the turntable 11 (e.g., on a chute area 119) to make adjustment and achieve balance of apparatus.

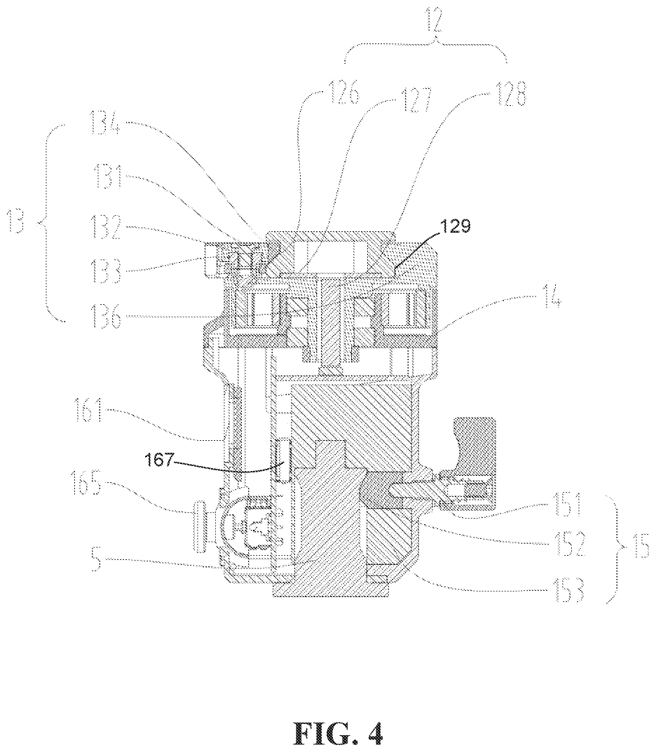

Further, in the second turntable 13, a pressing block 134 is arranged on a turntable main body 136. One or more springs spring 135 are arranged in respective cylindrical holes 139 on the turntable main body 136, and between the pressing block 134 and the turntable main body 136, so as to provide the function of restoring and rebounding the pressing block 134. A wrench 132 is connected to a toothed screw 133 and connected to the threaded hole 138 against the pressing block 134. The wrench 132 can be used to lock against the pressing piece 134, so as to lock the slide strip area 126 (e.g., FIG. 4) of the arm 12. The arm 12 can slide in the second turntable 13 (e.g., in a chute area 129) to make adjustment and achieve balance of the apparatus.

Further, the first turntable 11 and a drive motor assembly 121 of the arm 12 form a drive motor, and the two respectively form a rotor (turntable 11) of the motor and a stator (drive motor 121) rotating relative to the rotor. The first turntable 11 can rotate on (relatively to) the arm 12.

Further, the second turntable 13 and the main body 14 form a drive motor, and the two respectively form a rotor (turntable 13) of the drive motor and a stator (main body 14) rotating relative to the rotor. The second turntable 13 can rotate on (relative to) the main body 14.

As shown in FIGS. 2-4, the arm 12 includes a drive motor assembly 121 (e.g., FIG. 2), a drive circuit 122, an end cover 123, one or more screws 124, an arm 125, a slide strip region 126, an electric wire 128, and a cover plate 127. The drive motor assembly 121 is arranged in the arm 12 (e.g., in an enclosure at one end of the arm 12), and the drive circuit 122 is arranged above the motor assembly 121 (e.g., the drive circuit 122 covers the motor assembly 121). The electric wire 128 has an elastic telescopic function (e.g., for adjusting the length of the electric wire 128), one end of which is connected to the drive circuit 122, and the other end of which is connected to the control panel inside the main body 14 through the second turntable 13 to form the electronic control terminal 16 (or control interface). For example, the electric wire 128 can be connected to an interface circuitry (not shown) of the control terminal 16.

Further, the electronic control terminal 16 includes a display screen 161, a number of buttons (e.g., first button 162, a second button 163, a third button 164), and a control rocker lever 165. The electronic control terminal 16 can achieve intelligent control of the light path (e.g., the light path of a lamp 4) through software algorithms, including but not limited to, for example, light path scanning, object tracking, etc. The electronic control terminal 16 may include a controller or processor 167 configured to execute the software to effect control of the light path of the lamp.

As shown in FIGS. 1-5, the longitudinal arm 17 can include one or more elastic safety pins 171, a slide strip area 172, a mounting hole 173, and a screw 174. The elastic safety pins 171 have the elastic telescopic function and are arranged at both ends of the longitudinal arm 17. When the elastic safety pins 171 are pressed to contract (or retract), the longitudinal arm 17 can slide into the first turntable 11. The longitudinal arm 17 can slide onto the turntable 11 with at least one of the elastic safety pins 171 depressed (retracted). When elastic safety pins 171 protrude out, they prevent the longitudinal arm 17 from sliding into or out from the first turntable 11.

Further, the screw 174 can pass through the mounting hole 173 of the longitudinal arm 17 and is connected to a lamp interface 41 on the lamp 4, and the longitudinal arm 17 is connected to the lamp 4. When the longitudinal arm 17 slides into the first turntable 11, the mounting of the lamp 4 on the pan-tilt apparatus 1 is completed. The longitudinal arm 17 and the arm 12 (e.g., vertical arm) provide the adjustment and achieve dynamic balance of the lamp 4 or apparatus. Further, the light control pan-tilt apparatus 1 can control the spatial turning or positioning of the lamp 4, thus achieving the function of controlling the illumination path of the lamp 4.

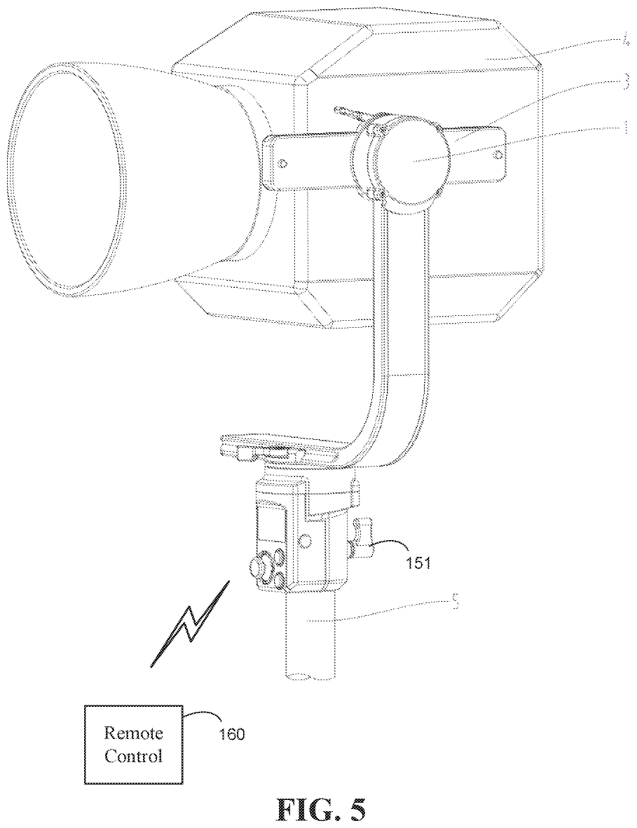

Further, a lamp tripod 5 (e.g., an interface of a lamp tripod is shown in FIG. 5) can be mounted in the main body 14, and a hand screw 151 (e.g., see FIG. 4) can pass through a mounting hole 153 against a pressing block 152, thereby fixing the interface of the lamp tripod 5 in the main body 14. In some aspects, a remote control 160 can remotely control the pan and tilt orientation of the lamp 4, for example, by a wired or wirelessly connection. For example, the remote control 160 can communicate with the control terminal 16 to control the motors in order to adjust the pan-tilt orientation of the lamp 4.

In some aspects, a pan-tilt device for a light source (e.g., lamp 4) is provided. The pan-tile device can include a bracket for mounting the light source. The bracket can include a longitudinal arm (e.g., arm 17) and an angled arm (e.g., arm 12). The longitudinal arm can be configured to couple the light source to the angled arm. The pan-tilt device can be provided with a first motor (e.g., formed by the first turntable 11 and the drive motor assembly 121) configured to rotate the longitudinal arm relative to the angled arm. The pan-tilt device can further provide with a second motor (e.g., formed by the second turntable 13 and main body 14) configured to pan the angled arm together with the longitudinal arm. In some aspects, the first motor and the second motor are configured to be controlled remotely (e.g., by the remote control 160).

In some aspects, the pan-tilt can include a controller (e.g., control terminal 16) configured to control the first motor and the second motor to move the light source from a first pan-tilt orientation to a second pan-tilt orientation. The pan-tilt device can include a wireless communication module to wirelessly communicate with a remote device (e.g., remote control 160) for controlling the pan-tilt orientation of the light source. In some aspects, the longitudinal arm can be slidably (e.g., using the slide stripe area 172) coupled to the angled arm. In some aspects, the second motor can be slidably (e.g., using the slide stripe area 126) coupled to the angled arm.

The above are only exemplary embodiments of the present disclosure, and are not intended to limit the present disclosure. Any modification, equivalent substitution and improvement made within the spirit and principle of the present disclosure should fall within the protection scope of the present disclosure.

1. A light control pan-tilt apparatus, comprising:
a center of gravity leveling mechanism for supporting a light source;
a first drive motor connected to a first end of the center of gravity leveling mechanism, configured to rotate the light source;
a second drive motor slidably connected to a second end of the center of gravity leveling mechanism, configured to rotate the center of gravity leveling mechanism; and
a control mechanism, fixedly connected to the second drive motor.

2. The light control pan-tilt apparatus of claim 1, wherein the center of gravity leveling mechanism comprises:
a lateral adjusting mechanism; and
a longitudinal adjusting mechanism configured to adjust the center of gravity of the light source corresponding to a center of the first drive motor,
wherein the lateral adjusting mechanism comprises a first slide strip area, the second drive motor comprises a first chute area slidably connected to the first slide strip area such that the lateral adjusting mechanism is able to slide relative to the second drive motor, and
wherein the longitudinal adjusting mechanism comprises a longitudinal arm including a second slide strip area, the first drive motor comprises a second chute area slidably connected to the second slide strip area such that the first drive motor is able to slide relative to the longitudinal arm.

3. The light control pan-tilt apparatus of claim 2, wherein the first drive motor comprises:
a first turntable comprising a first rotor part of a first drive motor; and
a first main body comprising a first stator part of the first drive motor,
wherein
the first turntable is configured to rotate relative to the first main body.

4. The light control pan-tilt apparatus of claim 1, wherein the control mechanism comprises:
a rocker control terminal for controlling a direction of the light control pan-tilt apparatus;
one or more buttons for controlling an operation mode of the light control pan-tilt apparatus; and
an internal circuit motherboard coupled to the rocker control terminal and the one or more buttons.

5. The light control pan-tilt apparatus of claim 4, wherein one end of the control mechanism is provided with an interface area for connecting the control mechanism on a tripod.

6. The light control pan-tilt apparatus of claim 1, wherein the control mechanism is configured to control a light path of the light source electronically online or remotely through software algorithm.

7. A pan-tilt device for a light source, comprising:
a bracket for mounting the light source, the bracket including a longitudinal arm and an angled arm;
the longitudinal arm configured to couple the light source to the angled arm;
a first motor connected to an end of the angled arm and slidably connected to the longitudinal arm, the first motor configured to rotate the longitudinal arm relative to the angled arm; and
a second motor slidably connected to the angled arm and configured to pan the angled arm together with the longitudinal arm.

8. The pan-tilt device of claim 7, wherein the first motor and the second motor are configured to be controlled remotely.

9. The pan-tilt device of claim 7, further comprising:
a controller configured to control the first motor and the second motor to move the light source from a first pan-tilt orientation to a second pan-tilt orientation.

10. The pan-tilt device of claim 7, further comprising:
a wireless communication module to wirelessly communicate with a remote device for controlling a pan-tilt orientation of the light source.

11. (canceled)

12. (canceled)

13. A system comprising a plurality of light pan-tilt apparatus as recited in claim 1, wherein the plurality of light pan-tilt apparatuses are jointly controlled through software algorithm, so as to achieve multi-effect processing of light.

14. The light control pan-tilt apparatus of claim 3, wherein the second drive motor comprises:
a second turntable comprising a second rotor part of the second drive motor; and
a second main body comprising a second stator part of the second drive motor,
wherein the second turntable is configured to rotate relative to the second main body.

15. The light control pan-tilt apparatus of claim 3, further comprising:
one or more elastic safety pins configured at respective ends of the longitudinal arm.
